(19) United States
(12) Patent Application Publication
(10) Pub. No.: US 2012/0008826 A1
(43) Pub. Date: Jan. 12, 2012

(54) METHOD, DEVICE AND COMPUTER PROGRAM PRODUCT FOR DETECTING OBJECTS IN DIGITAL IMAGES

(75) Inventors: Pranav Mishra, Bangalore (IN); GovindaRao Krishna, Bangalore (IN); Muninder Veldandi, Bangalore (IN); Roongroj Nopsuwanchai, Kanagawa (JP)

(73) Assignee: NOKIA CORPORATION, Espoo (FI)

(21) Appl. No.: 12/981,593

(22) Filed: Dec. 30, 2010

(30) Foreign Application Priority Data
Dec. 30, 2009 (IN) 3225/CHE/2009

(51) Int. Cl. G06K 9/00

(52) U.S. Cl. 382/103

(57) ABSTRACT

Method, device, and computer program product for detecting an object in a digital image are provided. The method includes providing a detection window and determining at least one area of the object in the digital image by traversing the detection window by a first step size onto a set of pixels. Further, at each pixel, presence of at least one portion of the object in the detection window is detected. Upon detection of the presence of the object, the detection window is shifted by a second step size to neighbouring pixels. Further, the detection window is selected as an area of the object if the at least one portion of the object is present in at least a threshold number of detection windows at the neighbouring pixels. Thereafter, an object area representing the object in the digital image is selected based on the at least one area.

### RELATED APPLICATIONS

This application claims priority to Indian Application No. 3225/CHE/2009 filed Dec. 30, 2009, which is incorporated herein by reference in its entirety.

### TECHNILCAL FIELD

The present disclosure generally relates to digital image processing, and more particularly, to a method, device and computer program product for detecting objects in digital images.

### BACKGROUND OF THE DISCLOSURE

In many applications of digital image processing, object detection is widely used. Examples of the object may include, but are not limited to, face of a person, any goods or vehicle, or any commodity to be scrutinized for security purposes. Object detection such as face detection may be defined as locating the existence of a face in a digital image. Face detection in the digital image may be utilized in applications such as face recognition, face tracking, photo tagging, image retrieval, security surveillance and improving quality of photographs in camera such as face priority, auto focus and auto balance, and so on.

In majority of digital image processing applications, object detection is performed by evaluating classifiers into different sections of the digital image. The classifiers correspond to the nature of object to be detected in the digital image. The classifiers are generally created using features extracted from similar digital images based on historic data and learning algorithms. The classifiers are described in details by Viola. P. et al., in a paper titled, ‘Robust Real-Time Face Detection’, as published in International Journal of Computer Vision, pp. 137-154, vol. 57, Issue 2 in year 2004. The classifiers are applied to a sub window within the digital image in order to detect the presence of the object. Further, for the detection of the object in the digital image, this sub-window is shifted incrementally across the digital image until the entire digital image is covered.

An exemplary digital image is schematically represented in FIG. 1. The digital image extends in X (width) and Y (height) directions. As shown in FIG. 1, the digital image has W pixels across the width and H pixels across the depth. A majority of the object detection techniques uses scanning the entire digital image through classifiers. In one such technique, a strong classifier is calculated for the sub-window. The sub-window may include an array of pixels, such as M×N pixels, where M and N are integers. In one technique, the sub-window is scanned across the digital image with a step size of one pixel. Scanning of the digital image with the step size of one pixel represents that the sub-window is traversed at each pixel of the digital image without skipping any pixel. Values of the classifiers are further calculated for the sub-window at each pixel of the digital image. Depending upon the values of the classifiers at a given pixel, presence of the object is detected within the detection window at the given pixel. In this technique, an object detection rate is quite high, as the presence of the object is checked at each pixel of the digital image. Herein, the objects detection rate refers to a percentage of correct detection of objects in a digital image. Further, in this technique, the object detection time is proportional to a multiplication of the height and width, for example, total number of pixels in the digital image, as sub-window is scanned at each pixel of the digital image.

In another known technique, the digital image is scanned by the sub-window at step sizes of more than one pixel, for example, 2 pixels. In this technique, the sub-window is traversed by skipping one pixel in the digital image. Accordingly, the time taken in scanning the digital image with step size of two pixels is smaller than the time taken in scanning the digital image with the step size of one pixel. However, the object detection rate while scanning with step size of two pixels deteriorates compared to the object detection rate with step size of one pixel.

In one representation, the time taken in scanning the digital image with step size of one pixel may be proportional to W*H, whereas the time taken in scanning the digital image with step size of two pixels may be proportional to W/2*H/2. Further, the object detection rate with step size of one pixel may be ‘R %’, and with step size of two pixels may be approximately (R-10) %. In these existing techniques, there is a trade off between the object detection rate and the time taken in scanning the digital image (processing time). For example, if the object detection rate is increased, the processing time also increases.

In light of the foregoing discussion, there is a need of efficiently detecting objects in a digital image.

### SUMMARY

General purpose of various embodiments is to describe a method, system and computer program product for detecting objects in a digital image.

In one aspect a method for detecting an object in a digital image having a plurality of pixels is provided. The method includes providing a detection window of M×N pixels of the plurality of pixels. Further, the method includes determining at least one area of the object in the digital image by traversing the detection window by a first step size onto a set of pixels of the digital image. At each pixel of the set of pixels, a presence of at least one portion of the object in the detection window is detected. The detection window is shifted by a second step size in a neighbouring region upon detection of the presence of the at least one portion of the object in the detection window. Furthermore, the method includes detecting a presence of at least one portion of the object in each detection window at neighbouring pixels. Moreover, the method includes selecting the detection window as an area of the object in the digital image if the at least one portion of the object is present in at least a threshold number of detection windows at the neighbouring pixels. Thereafter, an object area representing the object in the digital image is selected based on the at least one area of the object.

In an embodiment, the method detects the presence of the at least one portion of the object in the detection window by calculating a classifier value for the M×N pixels of the detection window. Further, the classifier value is compared to a first threshold number. The at least one portion of the object is detected as present in the detection window if the classifier value is greater than the first threshold number. In another embodiment, the presence of the at least one portion of the object is detected in the detection window by determining a probability of the presence of the at least one portion. The probability of the presence is determined by calculating a classifier value for the M×N pixels of the detection window. Further, the classifier value is compared to a second threshold number. The at least one portion of the object is likely to be present in the detection window if the classifier value is greater than the second threshold number.

In an embodiment, the second step size is smaller than the first step size. For example, the first step size may be two pixels and the second step size may be one pixel. Further, in an embodiment, the object area is selected based on a total area covered by the at least one area of the object. In another embodiment, the object area is selected based on an area common in the at least one area of the object.

In another aspect, a device is provided. The device includes at least one processor and at least one memory. The at least one memory includes computer program code, the at least one memory and the computer program code configured to, with the at least one processor, cause the device at least to perform: define a detection window of M×N pixels and to traverse the detection window from a first pixel to a second pixel across the digital image; determine at least one area of the object in the digital image by traversing the detection window by a first step size onto a set of pixels; at each pixel of the set of pixels: detect presence of at least one portion of the object in the detection window; shift the detection window by a second step size in a neighbouring region upon detection of the presence of the at least one portion of the object in the detection window; detect presence of the at least one portion of the object in detection windows at neighbouring pixels; and select the detection window as an area of the object in the digital image if the at least one portion of the object is present in at least a threshold number of the detection windows at the neighbouring pixels; and select an object area representing the object in the digital image based on the at least one area of the object.

In an embodiment, the at least one memory and the computer program code configured to, with the at least one processor, cause the device at least to calculate a classifier value for the M×N pixels of the detection window at a pixel and compare the classifier value to a first threshold number to detect the presence of the at least one portion in the detection window, wherein the at least one portion is present in the detection window if the classifier value is greater than the first threshold. In another embodiment, the at least one memory and the computer program code configured to, with the at least one processor, cause the device at least to detect the presence of the at least one portion of the object in the detection window based on a classifier value for the M×N pixels of the detection window, and comparison of the classifier value with a second threshold number. The at least one portion of the object is likely to be present in the detection window if the classifier value is greater than the second threshold number.

In an embodiment, the at least one memory and the computer program code configured to, with the at least one processor, cause the device at least to store at least one classifier, the first threshold number and the second threshold number. Further, in an embodiment, the second step size may be smaller than the first step size. For example, the first step size may be two pixels and the second step size may be one pixel. Furthermore, in an embodiment, the processor is configured to merge the at least one area to select the object area. In another embodiment, at least one memory and the computer program code configured to, with the at least one processor, cause the device at least to select the object area based on an area common in the at least one area of the object.

In yet another aspect, a computer program product for detecting an object in a digital image comprising a plurality of pixels is provided. The computer program product includes at least one computer-readable storage medium that includes a set of instructions configured to cause the device to at least: define a detection window of M×N pixels; determine at least one area of the object in the digital image by traversing the detection window by a first step size onto a set of pixels; at each pixel of the set of pixels: detect a presence of at least one portion of the object in the detection window; shift the detection window by a second step size in a neighbouring region upon detection of the presence of the at least one portion of the object in the detection window; detect a presence of the at least one portion of the object in each detection window at neighbouring pixels; and select the detection window as an area of the object in the digital image if the at least one portion of the object is present in at least a threshold number of detection windows at the neighbouring pixels; and a set of instruction for selecting an object area representing the object in the digital image based on the at least one area of the object.

In an embodiment, the set of instructions are further configured to cause device to at least calculate a classifier value for M×N pixels for the detection window at a pixel; and compare the classifier value to a first threshold number to detect the presence of the at least one portion in the detection window, wherein the at least one portion is present in the detection window if the classifier value is greater than the first threshold number. In another embodiment, the set of instructions are further configured to cause device to at least compare the classifier value to a second threshold number. The at least one portion of the object is likely to be present in the detection window if the classifier value is greater than the second threshold number. In an embodiment, the second step size is smaller than the first step size. For example, the first step size may be two pixels and the second step size may be one pixel. Further, in an embodiment, the object area is selected based on a total area covered by the at least one area of the object. In another embodiment, the object area is selected based on an area common in the at least one area of the object.

### BRIEF DESCRIPTION OF THE DRAWINGS

The above-mentioned and other features and advantages of various embodiments, and the manner of attaining them, will become more apparent and various embodiments will be better understood by reference to the following description taken in conjunction with the accompanying drawings, wherein:

FIG. 1 is a schematic diagram of a digital image;

FIG. 2 is a flow chart of a method for detecting an object in the digital image, in accordance with an embodiment;

FIGS. 3a and 3b are a flow chart of a method for detecting the object in the digital image, in accordance with another embodiment;

FIG. 4 is a block diagram of a device for detecting the object in the digital image, in accordance with an embodiment; and

FIG. 5 is a schematic diagram illustrating detection of the object in a digital image, in accordance with an embodiment.

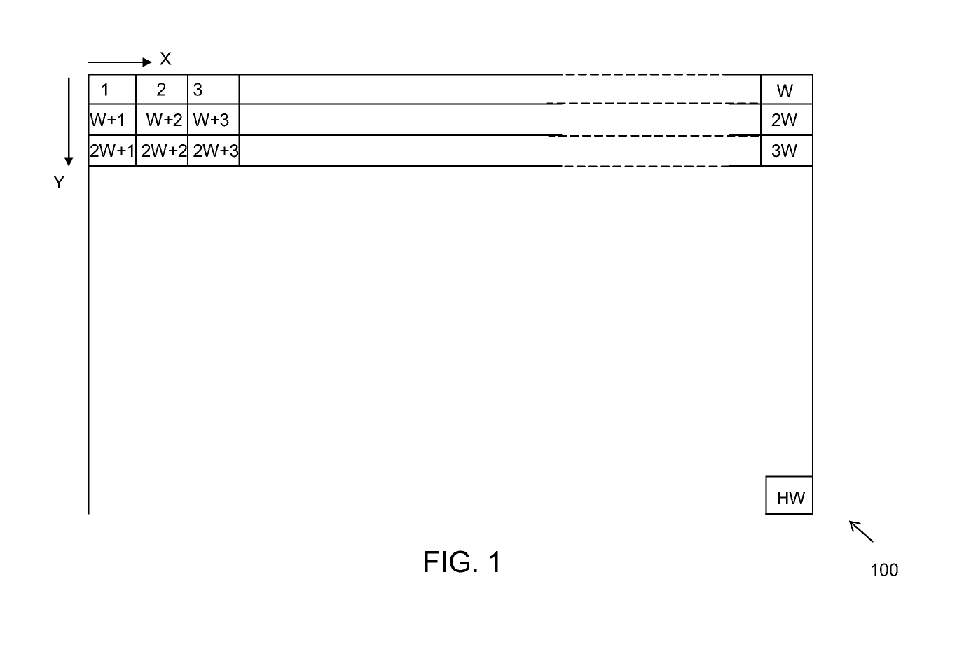

### DETAILED DESCRIPTION

It is to be understood that the present embodiments are not limited in its application to the details of construction and the arrangement of components set forth in the following description or illustrated in the drawings. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items.

The terms “a” and “an” herein do not denote a limitation of quantity, but rather denote the presence of at least one of the referenced item. Further, the use of terms “first”, “second”, and the like, herein do not denote any order, quantity, or importance, but rather are used to distinguish one element from another.

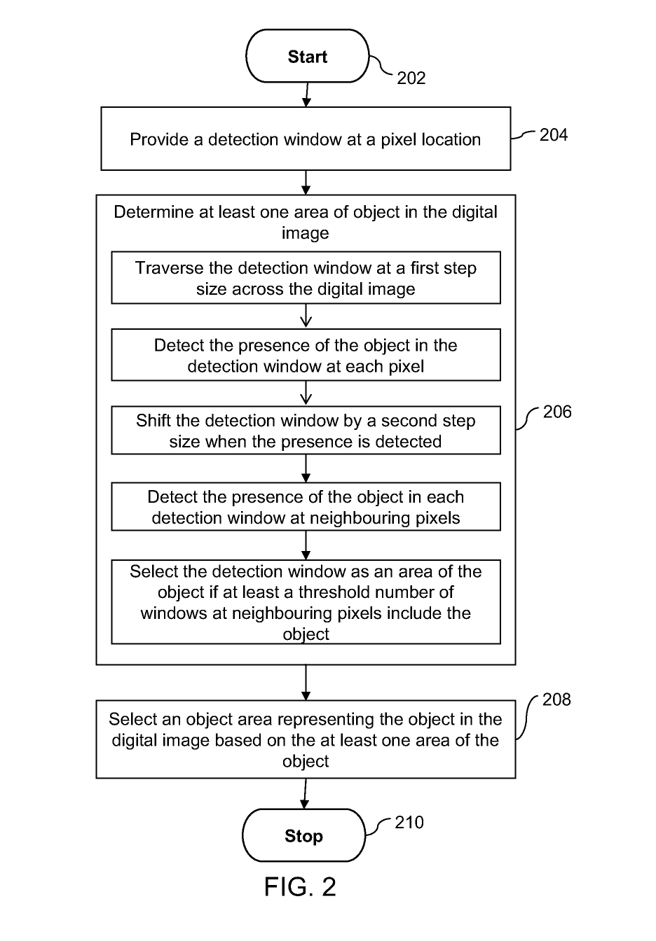

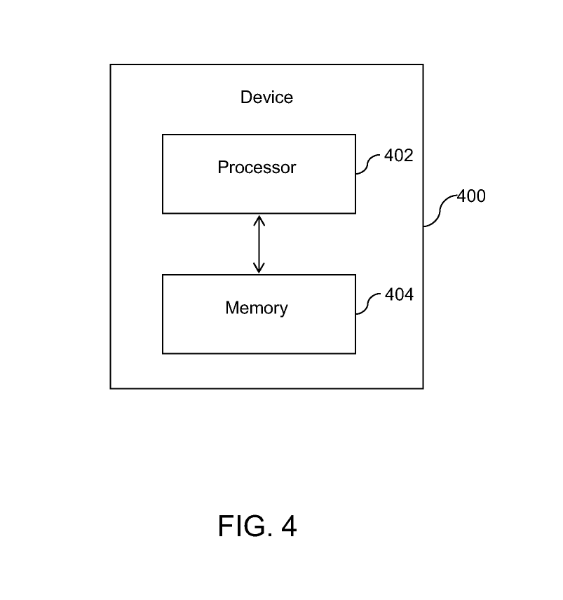

Various embodiments provide a method, system and computer program product for detecting objects in a digital image. The present disclosure provides detection of objects in the digital image by selectively switching between a coarse scanning and a fine scanning of the digital image. The present disclosure provides such switching between the coarse scanning and the fine scanning during detection of the object in order to increase object detection rate without substantially increasing processing time. Such method, system and computer program product are described in detail in conjunction with FIGS. 2, 3a, 3b and 4.

Referring now to FIG. 2, a flow chart of a method 200 for detecting an object in a digital image is illustrated, in accordance with an embodiment. The digital image, such as the digital image 100 may include a plurality of pixels. The method 200 starts at 202. Further, at 204, the method 200 includes providing a detection window of M×N pixels. M and N are integers and may be chosen based on the nature of the object to be detected and a resolution of the digital image. The detection window may be provided at a particular pixel in the digital image from where the scanning of the digital image may be started. For example, in one form, the detection window may be positioned at a top left pixel of the digital image.

Further, at 206, the method 200 includes determining at least one area of the object in the digital image. The detection window is traversed across the digital image starting from the pixel where the detection window is provided at 204. The detection window is traversed at a first step size onto a set of pixel. In one form, the first step size may be two pixels. Accordingly, the detection window may traverse at either odd numbered pixels in a row, or at even numbered pixels in the row. Further, after traversing a particular row, a next row of pixels may be skipped. For example, the detection window may be traversed at either odd numbered rows of pixels or even numbered rows of pixels, if the first step size is two pixels. Therefore, in the digital image 100 in one form, the set of pixels may include only even numbered pixels in either the even rows of pixels or the odd rows of pixels from total of H*W pixels of the digital image 100. In another form, the set of pixels may include only odd numbered pixels in either the even rows of pixels or the odd rows of pixels from total of H*W pixels of the digital image 100. For example, the detection window may be traversed at pixels represented by 1, 3, 5 . . . W, and 2W+1, 2W+3 . . . HW in the digital image 100.

While traversing the detection window at each pixel of the set of pixels, a presence of at least one portion of the object in the detection window is determined. For example, at a particular pixel, it is detected whether the detection window includes at least one portion of the object. Step size is changed to a second step size, if it detected that the detection window includes the portion of the object at the particular pixel. The detection window is further traversed by the second step size in a neighbouring region. For example, the detection window is traversed by the second step size to neighbouring pixels.

Further, at each neighbouring pixel, presence of the portion of the object is detected. In this embodiment, detection window at the particular pixel may be detected to include the portion of the object, if at least the threshold number of detection windows at the neighbouring pixels also includes the portion of the object. Such detection is based on the property of the classifiers that at least few of neighbouring pixels around the object should also be detected as the object. Accordingly, the detection window at the particular pixel may be selected as an area of the object if at least the threshold number of detection windows at the neighbouring pixel includes the portion of the object. As the detection window is traversed at each of the set of pixels, multiple areas of the object may be selected in the entire digital image.

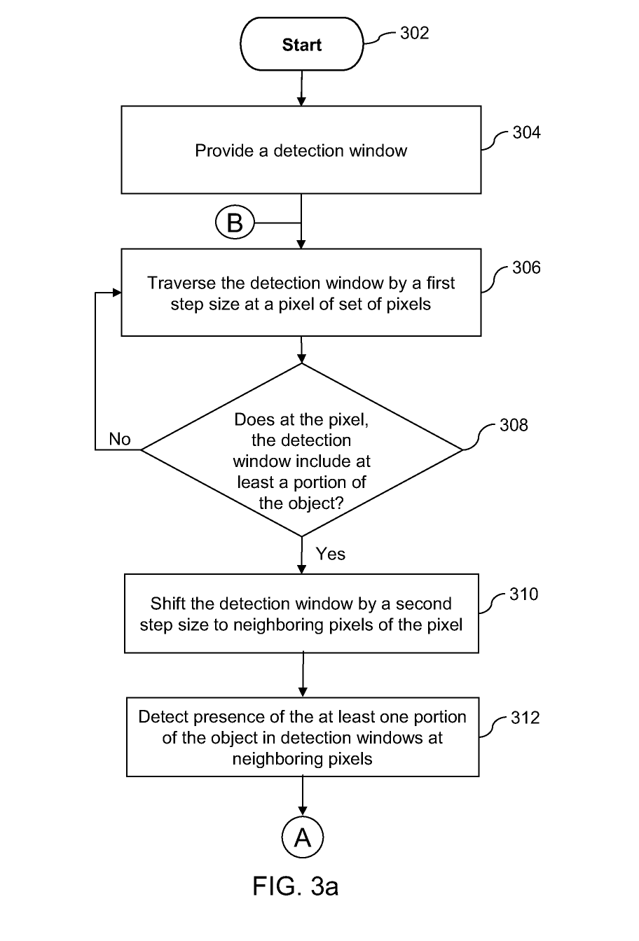

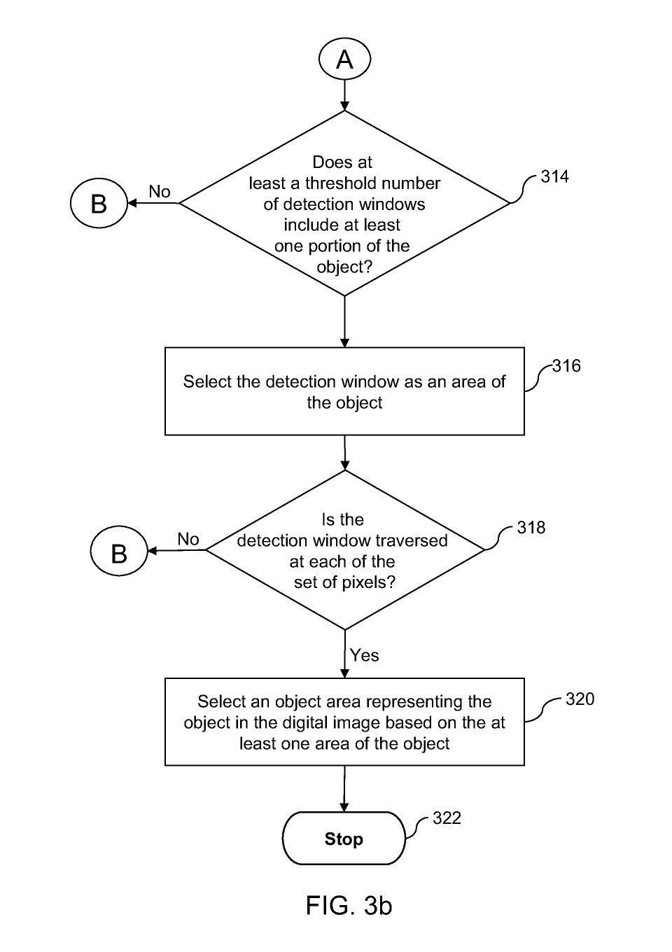

Further, at 208, an object area is selected based on the areas determined at 206. The object area in the digital image represents the detected object. Thereafter the method terminates at 208. A detailed method 300 for detecting the object in the digital image is in conjunction with FIGS. 3a and 3b.

FIGS. 3a and 3b show a method 300 for detecting object in the digital image, in accordance with another embodiment. The method 300 starts at 302. Further, at 304, the detection window is provided at a pixel. As described above, without limiting the scope of the method 300, the pixel may be a top left pixel in the digital image. Size of the detection window may be appropriately customized. For example, in one form, the detection window may be of 20×20 pixels. It should be understood that when the detection window is provided at a given pixel, it represents that a corner the detection window lies at the given pixel. For example, the top left corner of a 20×20 pixels detection window may lie at the given pixel, and detection window extends upto 20×20 pixels from the given pixel.

At 306, the detection window is traversed by a first step size to a next pixel of the set of pixels. The first step size may be any number of pixels, for example, two pixels or three pixels. Further, at 308, it is determined whether the detection window includes at least one portion of the object at the current pixel. Such detection is done by evaluating classifiers for the detection window at the current pixel. The top left corner of the 20×20 pixels detection window may be present at the current pixel, and the value of the classifiers are calculated for the 20×20 pixels detection window. The value of the classifiers (hereinafter referred to as ‘classifier value’) gives the output that is utilized to detect whether the detection window includes at least one portion of the object or not. It should be understood that ‘at least one portion of the object’ may refer to a section of the object or the entire object. For example, if the object is a face, the at least one portion of the object may refer to eyes, nose or the entire face. In another example, if the object is a vehicle, the at least one portion may refer to front wheels, rear wheels, or roof of the vehicle. For the sake of brevity, hereinafter ‘detection of at least a portion of the object’ will be referred by ‘detection of the object’, and it should not be considered limiting to the scope of the present method 300. It should also be understood that there may be multiple faces in the digital image, and herein the object may refer to the multiple faces present in the digital image. Accordingly, detecting the object can also refer to detecting the multiple faces in the digital image.

As explained earlier, the detection of the object is performed based on the classifier value for the detection window at the current pixel. In one form, the object is detected within the detection window present the current pixel, if the classifier value is greater than a first threshold number. The first threshold number may be determined based on the nature of the object and the digital image. Further, at 308, if it is determined that at the detection window does not include any portion of the object at the current pixel; the detection window is traversed to a next pixel at 306.

However, if it is determined at 308 that that the detection window at the current pixel includes the portion of the object, 310 is followed. In another embodiment of the present disclosure, if it detected at 308 that there is a likelihood of presence of the object in the detection window, the method 300 may proceeds to 310. For example, if it is found that there is a high probability that the object may be present at the current pixel, then without essentially waiting for the object to be detected at the current pixel, the method 300 may proceed to 310. For example, if the classifier value exceeds a second threshold number, it may be concluded that there is a substantial probability that the detection window would include the object. The value of the second threshold number may be selected based on the nature of object, experimental results related to object detection in the similar digital images. In one form, the value of the second threshold number is smaller than the first threshold number. In another form, the second threshold number may be equal to or more than the first threshold number.

At 310, the detection window is shifted by a second step size to neighbouring pixels. Without limiting the scope of the present method, in one form, the second step size is smaller than the first step size. For example, the second step size may be one pixel, and the detection window may be shifted to few or all of the eight neighboring pixels of the current pixel. It will be apparent to those skilled in the art that initially the detection window is scanned across the digital image at a first step size. Such detection of the object may be termed as a ‘coarse scanning’, as only the set of pixels of the plurality of pixels of the digital image are checked for the presence of the object in the detection windows thereon. Further, whenever the object is detected at a particular pixel, the step size is changed to the second step size, for example, from two pixels to one pixel. Further, the eight neighbouring pixels of the particular pixel are checked whether the detection windows at these neighbouring pixels include the object or not. Such detection at the neighbouring pixels may be termed as ‘fine scanning’. Detection windows at the neighbouring pixels are checked for the presence of the object in order to declare that the detection window at the particular pixel includes the object. It can be understood that the method 300 discloses selectively switching from the coarse scanning to the fine scanning if the object is detected or likely to be detected at the particular pixel.

In the fine scanning, in one form, each neighboring pixel is checked for the presence of the object. At 312 it is detected at each neighboring pixel, whether the corresponding detection window includes the object. At a given neighbouring pixel, presence of the object in the corresponding detection window may be detected based on the classifier value calculated for the corresponding detection window. Corresponding detection window may be detected to include the object, if the classifier value is greater than a threshold value. It should be noted that in one form, the threshold value may be equal to the first threshold number. In alternate forms, the threshold value may be less than the first threshold number, or may be equal to the second threshold number.

At 314, it is determined whether at least a threshold number of detection windows present at the neighboring pixels include the object. The threshold number may be selected based on the first step size and the second step size and various other factors such as the resolution of the digital image. In one form, the threshold number may be equal to four for the eight neighbouring pixels. If at 314, it is determined that at least the threshold number of detection windows do not include the object, 306 is followed. For example, if the detection windows at only two neighbouring pixels (less than the threshold number, for example, four) are detected to include the object, the detection window is traversed to a next pixel at 306.

If it is determined that at least the threshold number of detection windows includes the object, the method 300 proceeds to 316. For example, if it is detected that the detection windows at six neighbouring pixels (more than the threshold number, for example, four) include the object, 316 is followed. At 316, the detection window is selected as an area of the object. It may be detected that the detection window at the current pixel will includes the object, as detection windows at six neighbouring pixels also include the object. A person skilled in the art would appreciate that it may be detected that detection window at the current pixel includes the object; as such declaration is based on the property of the classifiers that the neighbouring pixels around the object should also be the object. Accordingly, at 316, the detection window at the current pixel is selected as an area of the object.

At 318 it is determined whether the detection window is traversed onto each of the set of pixels by the first step size. For example, it is determined whether the scanning of the entire digital image is completed or not. If it is determined that the detection window is not traversed at each pixel of the set of pixels, 306 is followed where again the detection window is traversed by a first step size to the next pixel. Thereafter, subsequent blocks 308 to 316 may be followed till it is determined whether the detection window at the next pixel includes the object or not for completely scanning the entire digital image by the detection window. It would be apparent to those skilled in the art that if the detection window is traversed onto each of the set of pixels, area(s) of the object in the digital image may be selected at 316. It should be understood that that the area(s) selected at 316 may relate to a single object, or to multiple number of similar objects such as multiple faces in the digital image.

If at 318, it is determined that the detection window is traversed onto the set of pixels of the digital image, for example, scanning of the digital image is complete, and the method 300 further proceeds to 320. At 320, the method 300 performs selecting the object area based on the area(s) selected at 318. It should be understood that in some cases the object may be present in only one detection window, for example, in one area. Further, it should also be understood that the object may be present in multiple detection windows, i.e., in multiple areas. Further, it should also be understood that in case of the object including multiple faces in the digital image, multiple areas may be selected at 318, where each area includes a face.

Further, at 320, an object area representing the object in the digital image is selected based on the at least one area of the object. Various ways may be utilized to select the object area based on the area(s) of the object. For example, in one way, area(s) of the object may be merged into a single area, which may be selected as the object area. In another form, a common overlapping area of the area(s) may be selected as the object area. It should also be understood that in case of multiple faces in the digital image, multiple areas may be selected as the object area in the digital image. Further, any other mathematical or graphical ways known in the art may also be utilized to select the object area from the areas(s) of the object. Thereafter, the method 300 for detecting the object in the digital image terminates at 322.

The present disclosure also provides a device 400, in accordance with one embodiment. In one form, the device includes at least one processor and at least one memory. The device 400 is shown to include a processor 402 and a memory 404. However, it will be apparent to a person skilled in the art that the device 400 can include more than one memory and more than one processor. The memory 404 includes computer program code. Examples of the at least one processor include, but are not limited to, one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). Examples for memory include, but are not limited to, a hard drive, a Read Only Memory (ROM), a Random Access Memory (RAM), Erasable Programmable Read-Only Memory (EPROM), Electrically Erasable Programmable Read-Only Memory (EEPROM), Programmable Read-Only Memory (PROM), CD-ROM, or flash memory

The memory 404 and the computer program code configured to, with the processor 402, cause the device 400 at least to provide a detection window. The detection window may be of M×N pixels as described in conjunction with FIGS. 3a and 3b. The device 400 may provide the detection window at a particular pixel in the digital image. For example, the detection window may be positioned at a top left pixel of the digital image. Further, the memory 404 and the computer program code configured to, with the processor 402, cause the device 400 at least to traverse the detection window from one pixel to another pixel.

The memory 404 and the computer program code configured to, with the processor 402, cause the device 400 at least In one form, the memory 404 and the computer program code configured to, with the processor 402, cause the device 400 at least the processor 402 is configured to traverse the detection window at a first step size onto a set of pixel of the digital image. In one specific embodiment, the first step size may be two pixels. While traversing the detection window onto the set of pixels, at each pixel, the memory 404 and the computer program code configured to, with the processor 402, cause the device 400 at least determine a presence of at least one portion of the object (hereinafter ‘at least one portion of the object’ is referred to as ‘object’) in the detection window. For example, at a particular pixel, the memory 404 and the computer program code configured to, with the processor 402, cause the device 400 at least to determine whether the detection window includes the portion of the object. If the device 400 determines that the detection window includes the object at the particular pixel, the memory 404 and the computer program code configured to, with the processor 402, may cause the device 400 to change the step size to a second step size from the first step size. The first step size and the second step size are already described in conjunction with FIGS. 2, 3a and 3b. The detection window is further traversed by the second step size in a neighbouring region of the particular pixel. For example, the detection window is traversed by the second step size to neighbouring pixels of the particular pixel.

Further, at each neighbouring pixel, the memory 404 and the computer program code configured to, with the processor 402, cause the device 400 at least to determine the presence of the object. As described in conjunction with FIGS. 3a and 3b, it will be detected that a detection window present at a given pixel includes the object, if at least a threshold number of detection windows at neighbouring pixels of the given pixel are also detected as including the object. Further, if it is detected that the detection window at the given pixel includes the object, the said detection window at the given pixel may be selected as an area of the object. Accordingly, the memory 404 and the computer program code configured to, with the processor 402, can cause the device 400 at least to select the detection window at the particular pixel as an area of the object, if at least the threshold number of detection windows at the neighbouring pixels includes the object.

Further, the memory 404 and the computer program code configured to, with the processor 402, cause the device 400 at least to traverse the detection window to the entire digital image, for example, at each pixel of the set of pixels. Accordingly, multiple areas of the object may be selected in the entire digital image. Further, the processor 402 is configured to select an object area based on the areas determined by traversing the detection window across the digital image. The object area in the digital image represents the detected object in the digital image.

In one embodiment, the memory 404 and the computer program code configured to, with the processor 402, cause the device 400 at least to detect the presence of the object in a detection window present at a pixel on the basis of a classifier value for the detection window. In one form, if the classifier value for the detection window is greater than a first threshold number, it represents that object is present within the detection window. In another embodiment, the memory 404 and the computer program code configured to, with the processor 402, cause the device 400 at least to detect a likelihood of the presence of the object in the detection window based on the classifier value. For example, if the classifier value for the detection window exceeds a second threshold number, it may be concluded that there is a substantial probability that the detection window includes the object. More specifically, if it is determined that there is a substantial probability of presence of the object in a detection window at a current pixel, then without essentially waiting for the object to be detected at the current pixel, the memory 404 and the computer program code configured to, with the processor 402, may cause the device 400 at least to switch to fine scanning in the neighbouring region. As described in conjunction with FIGS. 3a and 3b, the first threshold number and the second threshold number may be configured based on the nature of the object to be detected and the digital image.

In one embodiment, the classifiers, the first threshold number and the second threshold number may be stored in a memory 404 of the device 400. In some embodiments, the memory 404 may also be a part of the processor 402. Examples of the memory 404 may include one or more electronic device readable mediums such as a hard disk, a floppy disk, CD, CD-ROM, DVD, compact storage medium, flash memory, random access memory, read-only memory, programmable read-only memory, memory stick, or the like or combination thereof. The memory 404 may be configured to store the plurality of program instructions for execution by the processor 402.

Yet another embodiment provides a device including various means for detecting objects in the digital image. These means may be utilized for carrying out the methods 200 and 300, or the functionalities of the device 400, as described above. For example, the device may include means for providing the detection window, means for determining at least one area of the object by selectively traversing the detection window by a first step size and the second step size, and means for selecting the object area based on the at least one area of the object. Herein the means for determining the at least one area of the object may include means for calculating classifier value for the detection window and detecting the presence of the object in the detection window based on the classifier value. These means for detecting the objects in the digital image may be configured to perform the specified functions as described in flowchart of methods 200 and 300. For the sake of brevity of the description, the functionalities of these means for detecting the object is not described again as these functionalities are already described in conjunction with the flowchart of methods 200 and 300.

Further, it should be understood that these means for detecting the objects may be implemented in a hardware solution using electronic circuitries or neural network based devices, or even though as computer software code.

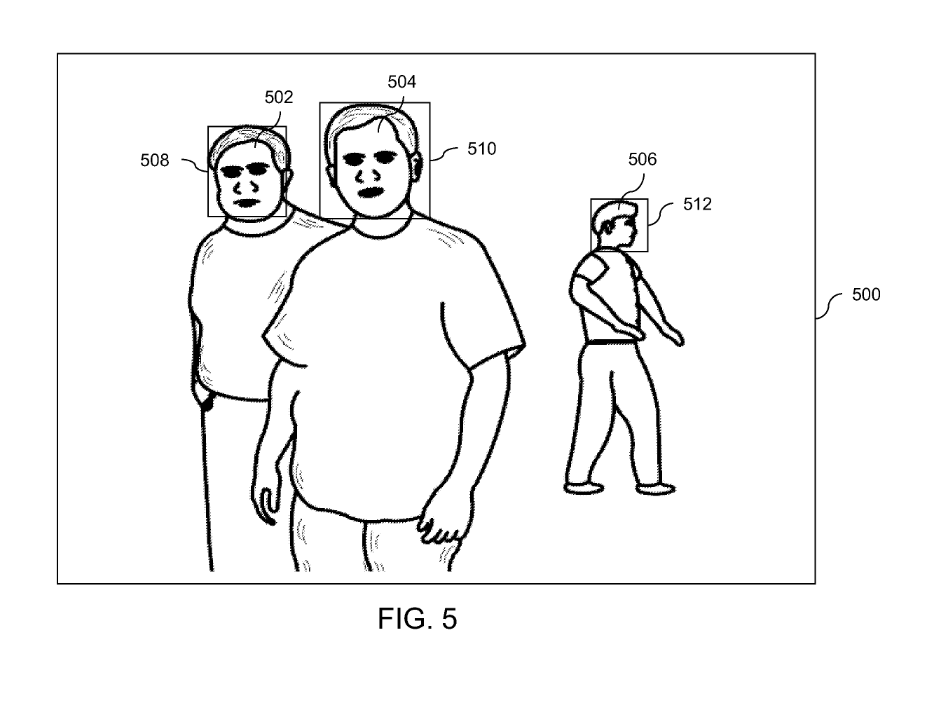

The methods 200 and 300, and the functionalities of the device 400 may further be understood with the help of an exemplary schematic representation, as shown in FIG. 5.

FIG. 5 illustrates a digital image 500 that includes objects such as faces 502, 504, and 506. The methods 200, 300, or the functionalities of the device 400 may be utilized to detect the faces 502, 504, and 506 in the digital image 500. A detection window is provided in the digital image 500. As described in conjunction with FIGS. 2, 3 and 4, the detection window may be provided at a top left pixel of the digital image 500. Further, the detection window is traversed by a first step size, for example by two pixels, to determine at least one area (also referred to as “area(s)) for each of the faces 502, 504, and 506 in the digital image 500.

At each pixel, it is detected that whether the detection window includes the object (a face, or a portion of the face). For example, at a particular pixel, it may be detected that the detection window includes the face 502. Once the face 502 is detected at the particular pixel, the step size of traversing the detection window is changed to the second step size, for example, one pixel. The detection window is traversed in the neighbouring region, for example, at each of the eight neighbouring pixels. Further, the presence of the face 502 is detected in the detection windows at eight neighbouring pixels.

Further, if it is determined that at least a threshold number of detection windows at the neighbouring pixels include the face 502, the detection window at the particular pixel may be selected as an area (not shown) of the face 502. The detection window is further traversed by the first step size across the digital image to find a next face location. It should be understood that multiple areas may be selected for the face 502, as the face 502 may be large enough to be entirely included in a single detection window. Accordingly, multiple detection windows may be selected as areas for the face 502.

The detection window is further traversed by the first step size (two pixels) across the digital image 500 to find the next face. Accordingly, similar to areas selected for the face 502, multiple areas may also be selected for the faces 504 and 506. In this way, the detection window is completely traversed throughout the digital image 500, and the multiple areas for the faces 502, 504 and 506 may be selected. Thereafter, object areas of the faces 502, 506 and 508 may be selected based on their corresponding areas. For example, object area of the face 502 may be selected based on the areas selected for the face 502. The object area for the face 502 is represented by an area 508 in FIG. 5. The area 508 represents the face 502 in the digital image 500. In one form, the area 508 may be selected by drawing an area that encloses each of the areas selected for the face 502. However, other ways may also be utilized for selecting the object area for the face 502 based on the areas selected for the face 502. Similarly, object area for the face 504 may also be selected based on the area selected for the face 504. The object area for the face 504 is represented by area 510. Similarly, the area 512 may be selected as an object area for the face 506.

It should be pointed out that a particular object, such as any of the faces 502, 504 and 506 may be enclosed in a single detection window or multiple detection windows. Accordingly, single or multiple areas may be selected for each of the faces 502, 504 and 506 based on the single detection window or the multiple detection windows, respectively. Further, the object areas for each of the faces 502, 504 and 506 may be selected based on their corresponding single or multiple areas. In an embodiment, size of the detection window may also be customized based on the pattern of the objects, such as the sizes of the faces 502, 504 and 506.

Furthermore, various embodiments may take the form of a computer program product for detecting an object in a digital image, on a computer-readable storage medium having computer-readable program instructions (for example, computer software) embodied in the computer-readable storage medium. Any suitable computer-readable storage medium (hereinafter ‘storage medium’) may be utilized including hard disks, CD-ROMs, RAMs, ROMs, Flash memories, optical storage devices, or magnetic storage devices.

The embodiments described above with reference to block diagrams and flowchart illustrations of methods and device. It will be understood that each block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable device to produce a machine, such that the set of instructions when executed on the computer or other programmable device create a means for implementing the functions specified in the flowchart block or blocks. Although other means for implementing the functions including various combinations of hardware, firmware and software as described herein may also be employed.

These computer program instructions may also be stored in a computer-readable medium that can cause a computer or other programmable device to function in a particular manner, such that the instructions stored in the computer-readable memory produce an article of manufacture including computer-readable instructions for implementing the function specified in the flowchart of the methods 200 or 300. The computer program instructions may also be loaded onto a computer or other programmable device to cause a series of operational steps to be performed on the computer or other programmable apparatus to produce a computer-implemented process such that the instructions that execute on the computer or other programmable apparatus provide steps for implementing functions/methods specified in the flowchart of the methods 200 and/or 300.

Based on the foregoing, the present disclosure provide detection of the object based on a selective switching between the coarse scanning and the fine scanning, while scanning the digital image by the detection window. This is done in order to increase the object detection rate without substantially increasing the processing time. For example, for the scanning of the digital image 100 with the first step size of one pixel and the second step size of two pixels, number of pixels on which the coarse scanning is performed are equal to (W/2)*(H/2). Further, assuming, there are ‘n’ number of faces in the digital image 100, so the fine scanning would also be performed at 8*n pixels. Therefore, the total number of pixels that are detected are equal to (W*H/4+8*(n)).

Those skilled in that art would appreciate that the processing time in detecting the object by the present disclosure will be slightly more than the processing time in scanning the digital image with uniform step size of two pixels (W*H/4), but will be significantly less than the processing time in scanning the digital image with uniform step size of one pixel (W*H). Similarly, the object detection rate achieved by the present disclosure will be slightly smaller than the object detection rate achieved by scanning the digital image with uniform step size of one pixel, but will be significantly improved than the object detection rate achieved by scanning the digital image with uniform step size of two pixels.

In an experimental study, a data set having around 1800 digital images were detected for the presence of objects such as faces. The digital images were detected by scanning the digital images with detection window by a uniform step size of one pixel, by a uniform step size of two pixels, and also by selectively scanning by step size of one pixel and two pixels as taught by the present disclosure, respectively. The experimental results suggest that the object detection rate in case of scanning with uniform step size of one pixel is 65% and the processing time is approximately 16 minutes. Further, the object detection rate in case of scanning with uniform step size of two pixels is 55%, and the processing time is approximately four minutes. However, the experimental results suggest that the object detection rate in case of selectively scanning by step sizes of two pixels and one pixel as taught by the present disclosure is 64.50%, and the processing time is 4.01 minutes. Therefore, it would be apparent to those skilled in the art that the present disclosure increases the detection rate without substantially increasing the processing time. It would further be apparent to those skilled in the art that the similar advantageous results will also be obtained for higher first step sizes and the second step sizes.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A method comprising:
providing a detection window of M×N pixels of a plurality of pixels in a digital image, wherein M and N are natural numbers;
determining at least one area of an object in the digital image by traversing the detection window by a first step size onto a set of pixels and by performing:
determining whether at least one portion of the object is present in the detection window;
shifting the detection window by a second step size in a neighbouring region upon detection of the presence of the at least one portion of the object in the detection window;
determining whether the at least one portion of the object is present in detection windows at neighbouring pixels; and
selecting the detection window as an area of the object in the digital image if the at least one portion of the object is present in at least a threshold number of detection windows at the neighbouring pixels; and
selecting an object area representing the object in the digital image based on the at least one area of the object.

2. The method of claim 1, wherein detecting the presence of the at least one portion of the object in the detection window comprises:
calculating a classifier value for the M×N pixels of the detection window; and
comparing the classifier value to a first threshold number, wherein the at least one portion of the object is present in the detection window if the classifier value is greater than the first threshold number.

3. The method of claim 1, wherein detecting the presence of the at least one portion of the object in the detection window comprises determining a probability of the presence of the at least one portion of the object by:
calculating a classifier value for the M×N pixels of the detection window; and
comparing the classifier value to a second threshold number, wherein the at least one portion of the object is likely to be present in the detection window if the classifier value is greater than the second threshold number.

4. The method of claim 1, wherein the second step size is smaller than the first step size.

5. The method of claim 1, wherein the first step size is two pixels and the second step size is one pixel.

6. The method of claim 1, wherein the object area is selected based on a total area covered by the at least one area of the object.

7. The method of claim 1, wherein the object area is selected based on an area that is common in the at least one area of the object and at least another area of the object.

8. A device comprising:
at least one processor; and
at least one memory comprising computer program code, the at least one memory and the computer program code configured to, with the at least one processor, cause the device at least to perform:
defining a detection window of M×N pixels of a plurality of pixels in a digital image, wherein M and N are natural numbers;
determining at least one area of an object in the digital image by traversing the detection window by a first step size onto a set of pixels and by performing:
determining whether at least one portion of the object is present in the detection window;
shifting the detection window by a second step size in a neighbouring region upon detection of the presence of the at least one portion of the object in the detection window;
determining whether the at least one portion of the object is present in detection windows at neighbouring pixels; and
selecting the detection window as an area of the object in the digital image if the at least one portion of the object is present in at least a threshold number of the detection windows at the neighbouring pixels; and
selecting an object area representing the object in the digital image based on the at least one area of the object.

9. The device of claim 8, wherein the at least one memory and the computer program code configured to, with the at least one processor, cause the device at least to further perform:
calculating a classifier value for the M×N pixels of the detection window at a pixel; and
comparing the classifier value to a first threshold number to detect the presence of the at least one portion in the detection window, wherein the at least one portion is present in the detection window if the classifier value is greater than the first threshold number.

10. The device of claim 9, wherein the at least one memory and the computer program code configured to, with the at least one processor, cause the device at least to further perform:
detecting the presence of the at least one portion of the object in the detection window based on:
a classifier value for the M×N pixels of the detection window; and
comparison of the classifier value with a second threshold number, wherein the at least one portion of the object is likely to be present in the detection window if the classifier value is greater than the second threshold number.

11. The device of claim 10, wherein the at least one memory and the computer program code configured to, with the at least one processor, cause the device at least to further perform:
storing at least one classifier, the first threshold number and the second threshold number.

12. The device of claim 8, wherein the second step size is smaller than the first step size.

13. The device of claim 8, wherein the first step size is two pixels and the second step size is one pixel.

14. The device of claim 8, wherein the at least one memory and the computer program code configured to, with the at least one processor, cause the device at least to further perform:
merging the at least one area of the object with at least another area of the object to select the object area.

15. The device of claim 8, wherein the at least one memory and the computer program code configured to, with the at least one processor, cause the device at least to further perform:
selecting the object area based on an area that is common in the at least one area of the object and at least another area of the object.

16. A computer program product comprising at least one computer-readable storage medium, the computer-readable storage medium comprising a set of instructions configured to cause a device at least to perform:
defining a detection window of M×N pixels of the plurality of pixels, wherein M and N are natural numbers;
determining at least one area of the object in the digital image by traversing the detection window by a first step size onto a set of pixels and by performing;
determining whether at least one portion of the object is present in the detection window;
shifting the detection window by a second step size in a neighbouring region upon detection of the presence of the at least one portion of the object in the detection window;
determining whether the at least one portion of the object is present in detection windows at neighbouring pixels; and
selecting the detection window as an area of the object in the digital image if the at least one portion of the object is present in at least a threshold number of detection windows at the neighbouring pixels; and
selecting an object area representing the object in the digital image based on the at least one area of the object.

17. The computer program product of claim 16, wherein the set of instructions are further configured to the device at least to perform:
calculating a classifier value for M×N pixels for the detection window at a pixel; and
comparing the classifier value to a first threshold number to detect the presence of the at least one portion in the detection window, wherein the at least one portion is present in the detection window if the classifier value is greater than the first threshold number.

18. The computer program product of claim 16, wherein the set of instructions are further configured to cause the device at least to perform:
detecting the presence of the at least one portion of the object in the detection window based on:
a classifier value for the M×N pixels of the detection window; and
comparison of the classifier value with a second threshold number, wherein the at least one portion of the object is likely to be present in the detection window if the classifier value is greater than the second threshold number.

19. The computer program product of claim 16, wherein the second step size is smaller than the first step size.

20. The computer program product of claim 16, wherein the first step size is two pixels and the second step size is one pixel.

21. The computer program product of claim 16, wherein the set of instructions are further configured to cause the device at least to perform:
merging the at least one area of the object with at least another area of the object to select the object area.

22. The computer program product of claim 16, wherein the object area is selected based on an area that is common in the at least one area of the object and at least another area of the object.
